(19) United States
(12) Patent Application Publication
(10) Pub. No.: US 2014/0265944 A1
(43) Pub. Date: Sep. 18, 2014

(54) LINEAR MAGNETIC MOTOR POWER GENERATION SYSTEM

(71) Applicant: Stephen Miles, Stuart, FL (US)

(72) Inventor: Stephen Miles, Stuart, FL (US)

(21) Appl. No.: 13/841,050

(22) Filed: Mar. 15, 2013

(51) Int. Cl. H02P 25/06

(52) U.S. Cl. CPC H02P 25/06
USPC 318/135

(57) ABSTRACT

A linear magnetic motor power generation system is disclosed. Multiple linear magnetic motors mechanically provide linear forces to equiangularly situated connecting rods pivotally attached to a crankshaft to produce rotary motion in the crankshaft. A control computer is used to implement a motion profile in commanding servo controllers that drive the linear motors to produce a desired reciprocating motion of the linear motors to generate a constant rotational velocity of the crankshaft. The crankshaft drives a rotary power generation device to generate AC power and an alternator to charge system batteries used for initial startup of the system.

### FIELD OF THE INVENTION

This invention relates in general to electric motors and more specifically to a linear magnetic motor adapted to rotate a shaft and drive a generator.

### BACKGROUND OF THE INVENTION

Linear magnetic motors have been known for some time but have enjoyed very limited application in creating rotary motion due to the kinematics involved, motor control issues and the difficulties in producing constant angular velocities in a rotary shaft from the forces produced by a linear motor. A well designed linear motor that includes low friction linear bearings capable of withstanding substantial forces and having high torque and power capabilities would provide a reliable source of power for generating rotary motion and turning a power generator. However, no such successful devices have been heretofore developed. One possible reason is the deviation in angular velocity that linear motors impart to a rotary shaft in a crank-slider configuration as a result of the inability to control the forces exerted by the linear motor with great precision. Another possible reason is the lack of an effective motor control mechanism for creating the desired linear motion that would impart a steady angular velocity in a driven crankshaft from a reciprocating linear motion. What is needed is a liner motor to rotary shaft mechanism that has very low frictional resistance, is highly efficient in the use of electrical power and also generates considerable rotational shaft torque for driving a rotary electrical power generation device.

### SUMMARY OF THE INVENTION

A linear magnetic motor driven power generation system, according to one aspect of the present invention, comprises a first linear motor having a first movable portion and a first stationary portion, and wherein said first movable portion is linearly movable with respect to said first stationary portion along a fixed distance travel path, said first linear motor further including a first motor input and wherein said first movable portion moves in accordance with a signal supplied to said first motor input, a first linear position encoder attached to said first linear motor for producing a first motor position signal corresponding to the location of said first movable portion of said first linear motor with respect to said fixed distance travel path, first motor control circuit means for supplying a drive signal to said first motor input, said motor control circuit means including a first motion input and a first position input responsive to said first motor position signal, said first control circuit means responding to signals applied to said first motion input to produce a first motor drive signal supplied to said first motor input to position said first movable portion of said first linear motor to any position within said fixed distance travel path in accordance with signals supplied to said first motion input, a crankshaft having a rotational axis and having a first offset journal situated a predetermined stroke distance from said rotational axis, a first connecting rod having a first end and a second end, said connecting rod rotatably attached to said first offset journal at said first end of said connecting rod, said first connecting rod being rotatably attached to said movable portion of said linear motor at said second end, and computer means including a processor, inputs, outputs and memory for executing a program in response to said first motor position signal and performing the following steps, a) providing a motion profile comprised of a plurality of sequential displacement positions for said linear motor and wherein said sequential displacement positions define absolute positions for said first linear motor along said fixed distance travel path that will sequentially position said crankshaft in all desired angular positions of said crankshaft, b) producing a first motor control signal supplied to said first motion input of said first motor control circuit means, said first motor control signal varying in accordance with said motion profile so that each of said plurality of sequential displacement positions are sequentially accessed in a predetermined time delay manner to produce a corresponding change in said first motor control signal, and c) continually repeating said producing step after all of said plurality of sequential displacement positions have been accessed to produce a corresponding change in said first motor control signal.

One aspect of the present invention is to provide an improved linear motor driven power generation system.

Another object of the present invention is to provide a linear motor driven system that produces a steady angular velocity rotary output.

Yet another object of the present invention is to utilize motion profiles in controlling a linear motor to achieve rotary motion.

These and other objects of the present invention will become more apparent from the following figures and description of the preferred embodiments.

### BRIEF DESCRIPTION OF THE DRAWINGS

FIG. 1 is a diagrammatic illustration of a linear magnetic motor power generation system according to one aspect of the present invention.

FIG. 2 is a schematic of control switches 39 of FIG. 1.

FIG. 3 is a kinematic diagram of a slider-crank mechanism as used in the present invention including formulas useful in calculating crankshaft and slider displacement relationships.

FIG. 4 is a diagrammatic illustration of another embodiment of a linear magnetic motor power generation system according to the present invention.

FIG. 5 is a flowchart describing the software executed by the controllers of FIGS. 1 and 4.

FIG. 6 is a detailed flowchart of the initialization step 64 of FIG. 5.

FIG. 7 is a detailed flowchart of the run linear motor program step 66 of FIG. 5.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Referring now to FIG. 1, a linear magnetic motor and power generation system 10 according to the present invention is shown. System 10 includes three linear magnetic motors, 12, 14 and 16. Each of the three motors 12, 14 and 16 consist of 2 component parts, a stationary base 12a, 14a and 16a, and a movable portion 12b, 14b and 16b that are movable in a linear direction. The movable portions 12b, 14b and 16b are pivotally coupled to connecting rods 18, 20 and 22. Connecting rods 18, 20 and 22 are pivotally mounted on crankshaft 24 at offset journals situated one hundred twenty degrees apart resulting in an evenly balanced crankshaft and enabling a balanced transfer of power from the linear motors to crankshaft 24. Crankshaft 24 is rotationally mounted on frame 25, preferably using roller or ball bearings to reduce friction. Crankshaft 24 is mechanically coupled to output shaft 26 which rotates with crankshaft 24 to provide rotary motion to the input shaft of generator 28. A pulley drive system 30 provides a rotational drive system to couple output shaft 26 to alternator 32. Alternator 32 produces a DC voltage output that is supplied to battery 34 and to DC-AC power inverter 36. Ideally, alternator 32 should be capable of several hundred amps output. The output of battery 34 is connected to a DC-AC power inverter device 36. Power inverter 36 produces a suitable 220 VAC signal that is provided to computer controller 38 and to servo controllers and drive electronics devices 40, 42 and 44. Servo controllers 40, 42 and 44 are electrically connected via cables 37 to motors 12, 14 and 16 to provide drive signals to move the motors and to receive position data from the linear position encoders or position transducers that are integrally a part of each motor 12, 14 and 16. Servo controllers 40, 42 and 44 receive various commands, including but not limited to, desired motor position, motor velocity and motor acceleration control commands from computer 38 and respond by positioning motors 12, 14 and 16m, respectively, in a desired physical position somewhere along the linear travel distance of motors 12, 14 and 16. Velocity and acceleration commands are also provided to servo controllers 40, 42 and 44 to instruct the servo controllers regarding these motion parameters when linear motor movement takes place. Computer controller 38 communicates with servo controllers 40, 42 and 44 in a bidirectional manner to provide motion control commands to the servo controllers as well as receiving data from the servo controllers regarding the position, status and operational characteristics of motors 12, 14 and 16. Control switches 39 include a number of mechanical switches that are user controlled to provide inputs to controller 38 for control of system 10. More detail regarding switches 39 is shown in FIG. 2. Linear motors 12, 14 and 16 are mechanically attached to rods 18, 20 and 22 via wrist pins 46.

Referring now to FIG. 2, a detailed schematic circuit for control switches 39 of FIG. 1 is shown. In particular, switch sw1 provides a start/stop signal to controller 38. Switch sw2 provides an input signal prompting controller 38 to enable the output drive signals for the servo controllers 40, 42 and 44. Switch sw3 provides an input to controller 38 to issue commands to the servo controller to move motors 12, 14 and 16 to a raised position. Switch sw4 provides an input for disabling the servo output drive signals to motors 12, 14 and 16. Switch sw5 provides an input signal to controller 38 for switching between low speed and high speed operation. Switch sw6 provides in input signal to instruct controller 38 to record the position of motors 12, 14 and 16 as being positioned in a designated home position. More detail regarding the functionality of switches sw1-sw6 is provided in conjunction with the description of the flowcharts of FIGS. 5-7.

Referring now to FIG. 1, controller 38 is preferably a programmable logic controller or PLC and such controllers are well known in the art of industrial equipment and automation systems. Controller 38 utilizes a bidirectional communications link 41 to communicate with servo controllers 40, 42 and 44. One such communications link implemented in system 10 and well known in the automation industry for communicating with servo controllers is the Sercos (Serial Real-time Communication System) interface, an adopted industry standard useful in high speed motion control interfaces used in industrial control systems. Sercos communication links utilize fiber optic data connections for immunity from magnetic interference and to take advantage of the high speed capability of data communications over fiber optic cables. Linear motors 12, 14 and 16 each include an integral absolute linear position encoder or position transducer that provides motor position feedback data to the corresponding servo controllers 40, 42 and 44. To position one of the linear motors 12, 14 or 16, controller 38 issues a command to one of the servo controllers including the desired motor position of the movable portion of the linear motor, and velocity and acceleration parameters associated with the motor movement. Current or amperage provided to the motors may also be controllable via interface 39.

Operating in an orchestrated sequence, controller 38 is programmed with an array of data points corresponding to linear motor positions for motors 12, 14 and 16 used to create the reciprocating linear motor movement necessary to impart rotary motion in crankshaft 24. The array of data points or data values used for the motion control of motors 12, 14 and 16 is referred to in the art as a motion profile.

A motion profile for a slider-crank mechanical mechanism such as motors 12, 14 and 16 coupled to crankshaft 24 is developed by use of the information shown in FIG. 3. FIG. 3 is a simplified illustration of the slider-crank mechanisms of motors 12, 14 and 16 coupled to crankshaft 24. FIG. 3 depicts the dimensional components of interest in a slider-crank mechanism that are used to develop a motion profile. L is the connecting rod length (corresponding to connecting rods 18, 20 and 22). R is the crankshaft 24 journal offset radius or distance from the axis of rotation of the crankshaft to the attachment location of the connecting rods. A is the angular position of crankshaft 24. Formula 43 is a well known formula from the Law Of Cosines, a relationship between the length of the legs of a triangle and the angles of a triangle, a trigonometric given in the analysis of our system. Formula 45 is derived directly from formula 43 by way of algebraic manipulations and some ingenious trigonometric substitutions so that the variable D is isolated and values for D may be readily calculated. Formula 45 is well known in the mechanical crank-slider arts. If crank radius R and connecting rod length L are known, a value for D is readily determined for any angle A using formula 45. The known lengths for L and R are used in conjunction with a sequential stepping (by one degree increments) through 360 degrees of motion for crankshaft 24 to produce a value D for each of 360 unique angular positions corresponding to each degree of rotation of crankshaft 24. Subtracting two times the radius R and subtracting the rod length L from each value for D results in an array of desired linear motor positions with a zero offset that, when programmatically supplied to the servo controllers by controller 38, will result in a constant angular velocity of rotation of crankshaft 24. The array of sequential values for D are determined by incrementing the value for angle A from 0 to 359 degrees, one degree for each increment, which results in a motion profile for positioning the movable portions of motors 12, 14 and 16 since the connecting rods and crankshaft journal offsets are all identical. One need only offset a pointer into the motion profile data values supplied to each motor by the angular offset of the connecting rod journals (assuming 120 degrees or 120 steps for an evenly balanced crankshaft having three connecting rods) to command all three motors to work together in an appropriate fashion. Thus, it follows that only one motion profile data array need be developed for controller 38 to control synchronized constant angular velocity movement of motors 12, 14 and 16 by commanding all three motors to move simultaneously in accordance with the calculated motion profile data.

Piston motion equations are well known in the art of mechanical linkages and one example of an Internet web page providing such crank-slider equations is http://en.wikipedia.org/wiki/Piston_motion_equations.

Operationally speaking, and after system initialization, controller 38 will issue a continuous series of positioning commands to servo controllers 40, 42 and 44 which in turn position motors 12, 14 and 16, respectively, into the appropriate linear position in order to generate rotary motion via crankshaft 24. As crankshaft 24 rotates, a rotary drive motion is provided to output shaft 26 and accordingly generator 28 and alternator 32 thereby producing DC power and AC power.

Those skilled in the art of computer programming and PLC programming may take any of various approaches in programming controller 38 to control servos 40, 42 and 44 and achieve the desired movement of linear motors 12, 14 and 16. One approach would be to establish a timer object in software having a very brief (e.g., one millisecond) time delay that triggers an activity at the expiration of the timer delay and appropriate positioning data in accordance with the motion profile data array discussed above is sent to the servo controllers 40, 42 and 44 to induce linear movement of the movable portions of motors 12, 14 and 16 into the appropriate position for rotational motion of crankshaft 24 after the expiration of each timer delay. This process would be repeated for each data value in the motion profile, developed using the formulas in FIG. 3. When all data values in the motion profile have been sent to the motors by controller 38 in a timed sequential fashion, controller 38 will sequence from a data value for crankshaft angular position at 359 degrees to the motor position value for the 0 degree position of crankshaft 24 and the profile data will again be sequentially provided to the servo controllers. For example if a crankshaft rotational speed of 360 RPM is desired, all values in the motion profile (360 values in our example) must be delivered to the servo controllers 360 times per minute, for a total of 360*360 or 129,600 times a minute, which translates to 2,160 times per second or approximately one positioning command every 0.462 milliseconds.

Alternatively, another approach to programming controller 38 to provide the motion profile data to the servos involves establishing a software object known as a virtual axis and to rotate the virtual axis at a predetermined angular rate. Then, a cam profile is defined in accordance with the motion profile data developed using formula 45 of FIG. 3. For each angular degree increment of the crankshaft 24, a corresponding distance D (FIG. 3) is determined which establishes the position desired for the linear motor. Offsets for the stroke distance (two times the radius R) and the connecting rod length L are accounted for. The motion profile values are mapped onto a virtual cam in software, commonly referred to as a cam profile. Each of the motors 12, 14 and 16 have a unique cam profile associated therewith, with each cam profile having data derived from the previously developed motion profile, the difference in each cam profile attributable to a 120 degree phase difference therebetween. The virtual cam profiles are “connected” to the rotating virtual axis, and the data for the cam profiles is delivered by controller 38 to servo controllers, 40, 42 and 44, in the form of motor torque and positioning commands to position motors 12, 14, 16, respectively, into the desired linear positions. Rotation of crankshaft 24 is then realized.

It is contemplated that the two software approaches discussed above are not the only approaches available, and other programming techniques may be taken or developed so that controller 38 may continually process the motion profiles developed for motors 12, 14 and 16 and provide positioning commands to the servo controllers 40, 42 and 44.

Referring now to FIG. 4, another embodiment of a linear magnetic motor and power generation system 50 is shown. All like numbered items in FIG. 4 are identical with the same numbered items of FIG. 1 and have the same features and characteristics. One primary difference between system 10 and system 50 is reflected in the configuration of crankshaft 24 within engine block 52. Another primary difference is in the features of linear motors 58, which are equipped with incremental position encoders versus the absolute position encoders of motors 12, 14 and 16 of FIG. 1. A slight inconvenience in the functionality of motors 58 is that their integrated incremental encoders require establishing a reference location for the moving portion of motors 58 each time they are powered up. Thus, additional initialization steps are required before system 50 is ready to produce rotary motion in crankshaft 24. Engine block 52 is shown in partial cross-sectional fashion to reveal the pistons and rods therein. In this embodiment, motors 58 mechanically contact the top of pistons 54. Pistons 54 are attached to the distal ends of connecting rods 18, 20 and 22 in typical fashion via wrist pins (not shown). Impact pads 56 are attached to the upper surfaces of pistons 54 to provide a mechanical interface between pistons 54 and the moving portions of motors 58. The purpose behind pads 56 is to prevent damage and wear atop pistons 54 and efficiently transfer mechanical energy from the linear motors to pistons 54. A hard rubber-like material or synthetic material is used for pads 56. System 50 teaches how one may convert a three cylinder engine block into a convenient crankshaft support and adapt same for interfacing with a linear motor drive system as shown. All other aspects of the items shown in FIG. 4 function identically as was described in conjunction with system 10 of FIG. 1.

A primary basis behind the configuration shown in FIG. 4 is a result of the currently available linear motors 58 in the market place and the fact that no known available linear motor products of sufficient torque and speed include absolute position encoders. Linear motors having sufficient torque and speed capabilities and including absolute linear position sensors are projected to be available in the near future and the system shown in FIG. 1 contemplates their usage. System 50 includes linear motors 58 that include incremental position encoders or transducers and each time controller 38 and motors 58 are powered up a process of “homing” or initializing the motors is required. The “homing” process includes establishing a home position for each of motors 58 prior to controller 38 implementing any motion profile positioning of the motors. Thus, an initialization process of manually positioning motors 58 into a home predetermined position that is referenced off the upper surface of engine block 52 and signaling controller 38 via switch sw6 that the motors are in the home position to trigger a position storing operation for the incremental position readings provided by motors 58 to the servo controllers is necessary prior to issuing any motor motion commands to servos 40, 42 and 44 to generate rotary motion in crankshaft 24. In all other operational aspects, system 50 is identical to system 10, such as, controller 38 will issue motor positioning commands corresponding to a desired motion profile to motors 58 in the same fashion as system 10.

Referring now to FIG. 5, a program flowchart for software executed by computer controller 38 is shown. The program flowcharts are applicable to both systems 10 and 50 except where noted. References to switch inputs are to those shown and described in reference to FIG. 2. Program execution begins at step 60 followed by the conditional at step 62 wherein the state of switch sw2, enable servo drive, is monitored by controller 38 and if the switch is in an enabled position then execution will continue at step 64. If switch sw2 is in the disabled position, program execution loops on step 62. At step 64 the system is initialized and mechanical initialization also takes place for system 50 where incremental position encoders are in use. Next at step 66, controller 38 executes code for the Run Linear Motor Program step to put the linear motors 12, 14, 16 or 58 in motion by providing motion profile data to the servo controllers 40, 42 and 44 in a continuous manner. Once the linear motor program begins running at step 66, switch sw4 is continually monitored at step 68 and if switch sw4 is in the disable servo position, execution returns to step 62. If at step 68 switch sw4 is in the enable position, the liner motor program continues to execute looping through steps 66 and 68 repeatedly. It should be noted that the basic operation of a PLC enables using any combination of switches as an enable input to the control software, and motor motion may be immediately halted in response to any programmed combination of inputs from the switches.

Referring now to FIG. 6, a detailed flowchart for the steps executed in step 64 Initialize System of FIG. 5 is shown. Execution begins at step 70 followed by step 72 where an operator must manually move linear motors 58 into a home position. Next at step 74, set home position switch sw6 is monitored and when enabled, execution continues at step 76 and the position of the linear motors is stored as an offset reference for use in adjustments to the motion profile data where the linear motors use an incremental position encoder. In the case of system 10 which includes linear motors with absolute position encoders, steps 74 and 76 are not necessary. If set home position switch sw6 is not enabled at step 74, execution will loop at step 74 indefinitely. Following Step 76, enable servo drive switch sw2 is monitored and if enabled, program execution will continue at step 80. If switch sw2 is not enabled at step 78, execution loops on step 78 until switch sw2 enable servo drive is enabled. Once switch sw2 is enabled, program execution continues at step 80 where raise motors switch sw3 is monitored by controller 38 and when closed, controller 38 issues motion commands to motors 58 to move the motors into a fully raised position. Steps 80 and 82 may be bypassed with system 10 since absolute encoders are used with linear motors 12, 14 and 16. Next at step 82, motor position offsets for home positions are applied to the motion profile data and the motors 58 are raised away from pistons 54. Then crankshaft 24 of FIG. 4 is positioned so that the piston in cylinder number one in engine block 52 is at a top dead center position establishing a starting reference point known to controller 38. It matters not which of the cylinders is designated as cylinder number one in system 50 so long as the same designation is always observed. For system 10 operation, crankshaft 24 does not require rotation to reach TDC of any of the connecting rods as absolute motor position information from the linear motors 12, 14 and 16 would provide sufficient feedback for determining crank angle position and for initializing the corresponding motion profiles for linear motors 12, 14 and 16. Thereafter at step 84 execution returns to the calling routine of FIG. 5.

Referring now to FIG. 7, a flowchart for step 66 of FIG. 5, Run Linear Motor Program, is shown. Following step 90, the linear motors of system 50 are moved to start positions and the cam profiles for motor 58 are loaded and initialized. For system 10, the linear motors need not be moved to a starting position since they are equipped with absolute position encoder devices so step 92 is skipped in the code for system 10. Next at step 94, the input from high/low speed switch sw5 is scanned and if high speed is selected, execution continues at step 98 and a cam virtual axis is set for a speed of 3240 degrees per second. Alternatively, if at step 94 switch sw5 is in the “low speed” position, then execution continues at step 96 and the cam virtual axis is rotated at 180 degrees per second. Following either steps 98 or 96 execution continues at step 100 where the virtual cam axis is enabled to rotate at the speed just set in steps 96 or 98. Next, at step 102, the linear motors are commanded to move to positions defined by the previously developed motion profile or cam profiles based on the angular position of the virtual cam axis assigned to each motor, remembering that each cam profile is offset by 120 degrees on the virtual cam axis for proper synchronization of motor motion and operation. Thereafter at step 104, if the input from start/stop switch sw1 indicates a request to halt the linear motor movement, then execution continues at step 106, the motors are halted, and in the case of system 50, the motors 58 are moved along their cam profiles to the start position prior to halting their motion. System 10 need does not require moving the motors to a start position at step 106. If at step 104 start/stop switch sw1 does not indicate a stop motors condition is desired, motor motion continues at step 102 and controller 38 continues to issue motor motion commands to the servo controllers to move the linear motors in accordance with the motion profiles set up as cam profiles. Following step 108 execution returns to the calling routine.

In the event linear motors with absolute position encoders are not available, it is contemplated that one skilled in the art could develop an external linear position encoder to achieve the desired functionality. Alternatively, if system 10 used linear motors with incremental encoders, a software could be developed to monitor the linear motor positions at startup while an operator rotated the crankshaft through at least one full revolution as the extreme linear positions of the motors are measured and stored as reference values for use in adjusting the motion profile data values.

A list of component parts used in constructing the embodiments described above include the following:

Linear Motors (item 58): Rockwell Automation/Allen Bradley Linear Motors: LDAT S076020 DBS; LDAT Series Integrated Linear Thruster, 75 mm Wide Motor, 600 Length Motor, 20 cm Travel Length, D Winding High Speed, B Incremental TTL Encoder.

Motor Cables (item 37): 2090 XXNFMF-S05 Motor Feedback cable and 2090 CPWM7DF 14AA04 Motor Power Cable.

Servo Controller (items 40, 42 and 44): Rockwell Automation/Allen Bradley Ultra 3000 servo controllers

Computer Controller (item 38): CompactLogix L43 Processor

Interface Cable/Sercos (item 41): 1768 M04SE 4 Axis Sercos Module.

Generator (item 28): Dayton Generator 2MV67 25 hp 12 kva

DC-AC Converter (item 36): Aims 8000 12 v/220 v AC power inverter

Although three motor systems are disclosed, it is feasible that a system could designed that used a single linear motor, with the only disadvantage being that the linear motor would need to be positioned in the middle of its normal linear travel excursion so that initial forces applied thereto would enable linear to rotary motion, thereby avoiding the potential lockup locations of a top dead center or bottom dead center positioning of the crank/rod assembly. The use of a weighted flywheel on the crankshaft would serve to encourage rotation through the lockup locations and prevent an undesirable stop in the lockup locations of the crankshaft. Similar considerations are raised and could be addressed with a two linear motor system.

While the invention has been illustrated and described in detail in the drawings and foregoing description of the preferred embodiments, the same is to be considered as illustrative and not restrictive in character, it being understood that only the preferred embodiments have been shown and described and that all changes and modifications that come within the spirit of the invention are desired to be protected.

What is claimed is:

1. A linear motor driven power generation system comprising:
a first linear motor having a first movable portion and a first stationary portion, and wherein said first movable portion is linearly movable with respect to said first stationary portion along a fixed distance travel path, said first linear motor further including a first motor input and wherein said first movable portion moves in accordance with a signal supplied to said first motor input;
a first linear position encoder attached to said first linear motor for producing a first motor position signal corresponding to the location of said first movable portion of said first linear motor with respect to said fixed distance travel path;
first motor control circuit means for supplying a drive signal to said first motor input, said motor control circuit means including a first motion input and a first position input responsive to said first motor position signal, said first control circuit means responding to signals applied to said first motion input to produce a first motor drive signal supplied to said first motor input to position said first movable portion of said first linear motor to any position within said fixed distance travel path in accordance with signals supplied to said first motion input;
a crankshaft having a rotational axis and having a first offset journal situated a predetermined stroke distance from said rotational axis;
a first connecting rod having a first end and a second end, said connecting rod rotatably attached to said first offset journal at said first end of said connecting rod, said first connecting rod being rotatably attached to said movable portion of said linear motor at said second end; and
computer means including a processor, inputs, outputs and memory for executing a program in response to said first motor position signal and performing the following steps:
a) providing a motion profile comprised of a plurality of sequential displacement positions for said linear motor and wherein said sequential displacement positions define absolute positions for said first linear motor along said fixed distance travel path that will sequentially position said crankshaft in all desired angular positions of said crankshaft;
b) producing a first motor control signal supplied to said first motion input of said first motor control circuit means, said first motor control signal varying in accordance with said motion profile so that each of said plurality of sequential displacement positions are sequentially accessed in a predetermined time delay manner to produce a corresponding change in said first motor control signal; and
c) continually repeating said producing step after all of said plurality of sequential displacement positions have been accessed to produce a corresponding change in said first motor control signal.
